(19) United States
(12) Patent Application Publication
(10) Pub. No.: US 2006/0055666 A1
(43) Pub. Date: Mar. 16, 2006

(54) Method for controlling illumination employed by a computer pointing peripheral and computer pointing peripheral

(76) Inventors: Tan Shan Chong, Selangor (MY); Liew Tong Sen, Perak (MY); Bernard Chan Lye Hock, Penang (MY)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/942,653

(22) Filed: Sep. 14, 2004

(51) Int. Cl. G09G 5/00

(52) U.S. Cl. 345/156

(57) ABSTRACT

In one embodiment, a method of operating a computer pointing peripheral comprises capturing images of a support surface to perform navigational analysis, analyzing at least one image characteristic, modifying an image exposure time in response to the analyzing, and modifying an intensity of illumination of the support surface when the image exposure time fails to satisfy an operating parameter.

### TECHNICAL FIELD

The present application is generally related to computer pointing peripherals that employ optical navigation functionality.

### BACKGROUND

Most graphical user interfaces (GUIs) primarily rely on “mouse” peripherals to control the interactions between a software program and the user. Traditional mouse peripherals utilize a “ball” structure that relies upon mechanical/electrical mechanisms to generate signals indicative of user movement of the device. The traditional mouse design is problematic, because the mechanical portions of the device are subject to deterioration and become largely inoperable upon contamination. A relatively common experience with traditional mouse peripherals is the inability to move a graphical pointer in a specific direction. For example, the user might be able to move the graphical pointer of a GUI up, left, and right, while being unable to readily move the graphical pointer down using an inoperable traditional mouse.

Optical mouse peripherals have been developed that do not become readily inoperable due to contamination. Optical mouse peripherals generally operate by repetitively illuminating a surface, capturing images of the surface, and estimating the movement of the device through successive images. The advantage of optical mouse peripherals is that dirt or other contaminants may be simply removed from windows that protect the optical elements. Accordingly, optical mouse peripherals exhibit greater reliability and performance than traditional devices. Also, optical mouse peripherals may operate on a large number of surfaces and do not require “mouse pads.”

FIG. 1 depicts a block diagram of mouse 100 that uses repetitive image analysis to generate signals indicative of user movement of the mouse 100. As shown in FIG. 1, mouse 100 includes image array 101 (e.g., a charge-coupled device) coupled to analog-to-digital converter (ADC) 102. The digital data of an image of the surface on which the mouse 100 is operated is provided to DC removal (DCR) element 103. DCR element 103 is a digital filter that removes the DC component of a digital image. Additional details related to DCR 103 may be found in U.S. Pat. Nos. 6,049,338 and 6,047,091 which are incorporated herein by reference. From DCR element 103, digital data from successive images is provided to reference memory 104 and comparison memory 105.

Cross-correlator logic 106 performs a window searching procedure between reference memory 104 and comparison memory 105. For each offset position over a range of offset positions, cross-correlator logic 106 calculates the correlation between the overlapping portions of the image data stored in comparison memory 105 and reference memory 104. Generally, the offset position that is associated with the highest correlation provides the best estimate of the movement of mouse 100 between the respective images. Navigator logic 107 analyzes the correlation values to generate a stream of ΔX and ΔY values that are indicative of the user movement of the device. Additional details related to the processing of image data to estimate the navigation of a computer peripheral device may be found in U.S. Pat. No. 5,644,139 which is incorporated herein by reference.

The performance of navigator logic 107 in tracking the actual movement of mouse 100 depends upon the uniform illumination of the supporting surface. Accordingly, mouse 100 adjusts the image exposure time upon a continuous basis to obtain pixel data meeting one or several criteria. Specifically, as shown in FIG. 1, mouse 100 further includes pix monitor logic 108 that analyzes the image quality. Pix monitor logic 108 may perform an averaging operation as pixel elements are scanned from image array 101. Additionally or alternatively, pix monitor logic 108 may determine the maximum pixel value as an entire image is scanned from image array 101. In response to the analysis of the pixel information, pix monitor logic 108 maintains, increases, or decreases the shutter exposure time using frame period counter (FPC) 109. FPC 109 is a counter that fires a “Frame_Start” interrupt signal to trigger the digital block on every start of the frame. If the image values are too low, the shutter exposure time will be increased to improve image brightness. If pixel element saturation occurs, the shutter exposure time will be decreased to maintain image quality.

### SUMMARY

Although optical mouse peripherals provide significant advantages, known optical mouse peripherals do not perform at a high level under all circumstances. Specifically, known optical mouse peripherals use a constant current drive method to power the light source. When a laser, highly directional light source, or coherent light source is used to illuminate a highly reflective surface (e.g., shiny metal plate, glossy photo prints, high gloss wooden surfaces, and/or the like), the array of image data exhibits a wide dynamic range and may contain one or more saturated values. The saturated values signal typical shutter control functionality to decrease the exposure time to an unacceptable low level. The consequence of such action is that the low exposure time is susceptible to oscillation due to high percentage of change of image characteristics per step (the discrete movement between successive images). The image quality and, hence, tracking performance of the optical navigation deteriorates under such conditions.

In another case, when a laser, highly directional light source, or coherent light source is used to illuminate a dark surface (e.g., dark cloth, black velvet and/or like), the low image values signal the shutter control functionality to increase the exposure time to the maximum allowable value. The consequence such action is that the speed or the frame rate of the mouse is lowered and even at maximum shutter time, potentially the image quality is low due to insufficient illumination. Thus, tracking performance deteriorates.

Some representative embodiments include automatic gain control functionality to control the drive current provided to the light source of an optical mouse peripheral. Specifically, some representative embodiments monitor a shutter feedback signal in conjunction with the monitoring of the pixel characteristics. When the shutter feedback signal drifts from a predetermined range, some representative embodiments modify the current provided to the light source. The modification of the drive current enables the shutter feedback signal to be maintained within appropriate values and image quality is maintained for navigation purposes. Specifically, the automatic gain control functionality enables a stable and reasonable shutter exposure time to be obtained.

### BRIEF DESCRIPTION OF THE DRAWINGS

FIG. 1 depicts a block diagram of a known optical mouse peripheral.

FIG. 2 depicts a block diagram of an optical mouse peripheral according to one representative embodiment.

FIG. 3 depicts a flowchart according to one representative embodiment.

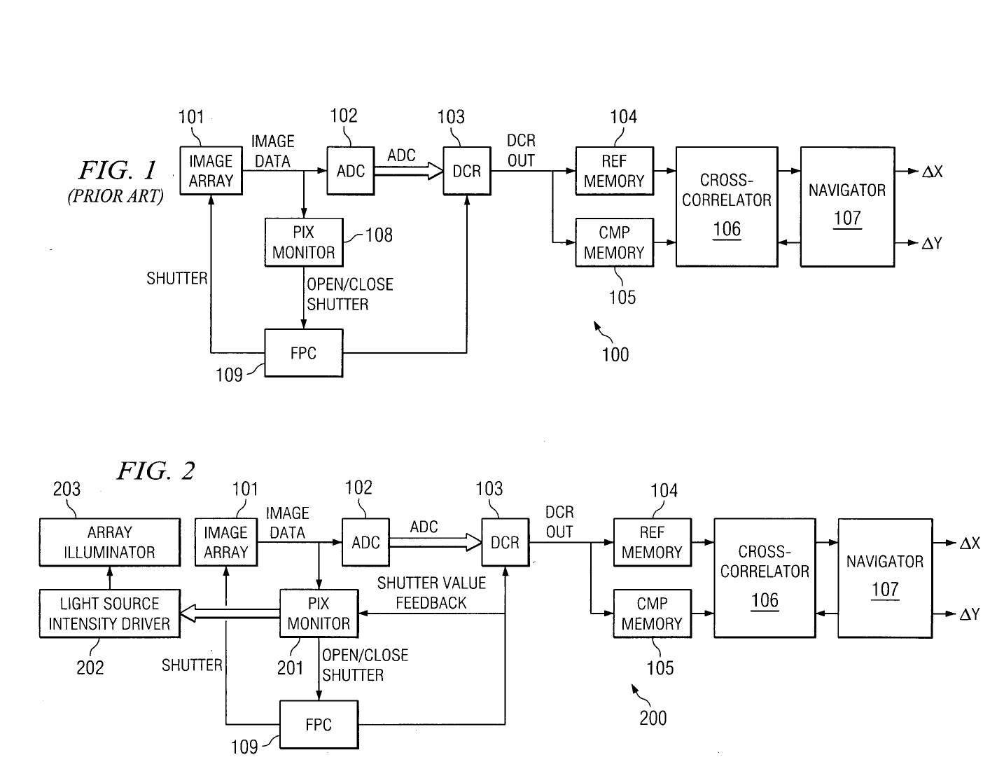

### DETAILED DESCRIPTION OF THE INVENTION

FIG. 2 depicts a block diagram of optical mouse peripheral 200 according to one representative embodiment. The navigation functionality of mouse 200 operates substantially the same as the navigation functionality of mouse 100. Specifically, image array 101 captures images of the supporting surface and analog-to-digital converter (ADC) 102 converts the analog signals from respective pixel elements of image array 101 into digital data. The digital data is provided to DCR element 103 and the data is then provided to reference memory 104 and comparison memory 105. Cross-correlation logic 106 calculates the correlation between image portions of reference memory 104 and portions of comparison memory 105. Navigator logic 107 analyzes the correlation values to generate a stream of ΔX and ΔY values that are indicative of the user movement of the device.

As shown in FIG. 2, pix monitor logic 201 performs analysis of image characteristics in the analog domain. However, pix monitor logic 201 may alternatively be coupled to receive image data from ADC 102 to perform image analysis in the digital domain if desired. If image characteristics do not meet desired criteria, pix monitor logic 201 increases or decreases the exposure time of image array 101 by controlling a shutter through FPC 109. For example, pix monitor logic 201 may send messages to FPC 109 to increase or decrease the exposure time. FPC 109 generates timing signals to control the shutter for exposure of image array 101 and for DCR element 103 to obtain digital data of an image using ADC 102. In one representative embodiment, pix monitor logic 201 is coupled to FPC 109 to receive the same timing signal provided to the shutter functionality and DCR element 103. Pix monitor logic 201 is thereby enabled to monitor the length of the exposure time (e.g., in terms of clock cycles).

When pix monitor logic 201 determines that the length of the exposure time has deviated from a predetermined range, pix monitor logic 201 communicates a suitable signal to light source intensity driver 202. Depending upon the signal, light source intensity driver 202 increases or decreases the drive current provided to array illuminator 203. For example, the output power of array illuminator 203 may be reduced and the image light received by image array 101 may be reduced. Pix monitor logic 201 may continue to signal light source intensity driver 202 to decrease drive current until a stable and reasonable shutter value (e.g., exposure time in terms of clock cycles) is obtained.

The elements of mouse 200 shown in FIG. 2 may be implemented using integrated circuit elements. In other embodiments, software instructions executed on a suitable processor could be alternatively or additionally employed. For example, the analysis of exposure time and the generation of a signal to change the intensity of the drive current could be performed using executable software instructions on a computer system (not shown) if desired.

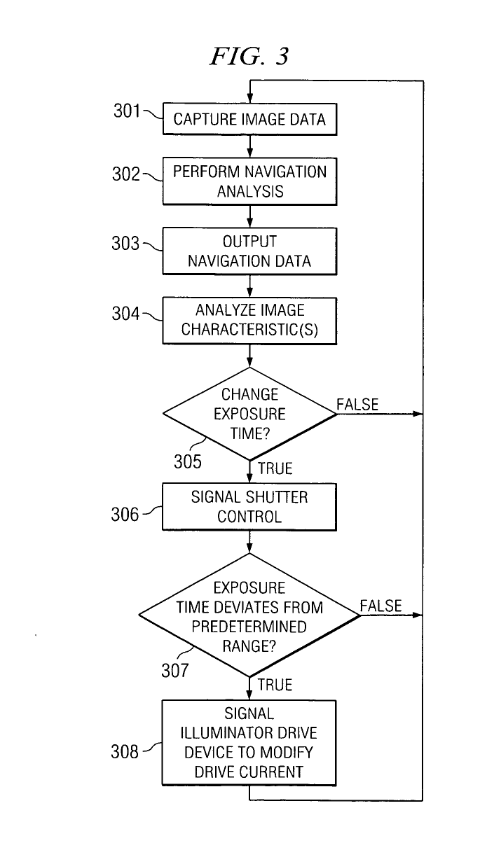

FIG. 3 depicts a flowchart for operation of an optical mouse according to one representative embodiment. The description of the flowchart uses a linear description of operations for the convenience of the reader. However, implementations of the flowchart need not impose a rigid timing relationships to the performance of the various operations. For example, integrated circuit elements may perform some of the timing relationships in parallel.

In step 301, image data is captured using, for example, a CCD array element and an analog-to-digital converter. In step 302, navigation analysis is performed. In step 303, navigation data is output from the optical mouse via a suitable interface. Steps 301 through 303 may be performed using known functionality employed in commercially available optical mouse peripherals.

In step 304, image characteristics are analyzed. For example, the average pixel value may be determined. Additionally or alternatively, the maximum pixel value of the entire array may be determined. In step 305, a logical comparison is made to determine whether to change the exposure time. In one embodiment, the average pixel value and maximum pixel value are compared to respective parameters to make the determination. If the logical comparison of step 305 is false, the process flow proceeds from step 305 to step 301. If the logical comparison is true, the process flow proceeds from step 305 to step 306 where a signal is communicated to a shutter control mechanism to change the exposure time

In step 307, a logical comparison is made to determine whether the exposure time deviates from a predetermined range. If false, the process flow returns to step 301. If true, the process flow proceeds to step 308 where a signal is provided to an illuminator drive device to modify the drive current. Thereby, the illumination of the support surface is modified and the exposure time may be brought within the predetermined range. Accordingly, oscillation of the exposure time is avoided, image quality is improved, and the accuracy of the navigation analysis is improved. From step 308, the process flow returns to step 301.

What is claimed is:

1. A method of operating a computer pointing peripheral, comprising:
capturing images of a support surface to perform navigational analysis to generate data indicative of movement of said computer pointing peripheral for output to a computer system;
analyzing at least one image characteristic;
modifying an image exposure time in response to said analyzing; and
modifying an intensity of illumination of said support surface when said image exposure time fails to satisfy an operating parameter.

2. The method of claim 1 wherein said modifying an intensity of illumination comprises:
modifying a drive current provided to an illumination device used to illuminate said support surface.

3. The method of claim 2 wherein said illumination device is a coherent light source.

4. The method of claim 2 wherein said illumination device is a highly directional light source.

5. The method of claim 1 wherein said analyzing at least one image characteristic determines whether an average pixel value is above a threshold value.

6. The method of claim 1 wherein said analyzing at least one image characteristic determines whether a maximum pixel value is above a threshold value.

7. The method of claim 1 wherein said modifying an exposure time modifies a shutter operation according to a number of clock cycles.

8. The method of claim 7 further comprising:
determining whether said number of clock cycles is within a predetermined range.

9. A computer pointing peripheral, comprising:
an illumination element for illuminating a support surface;
an imaging array for capturing images of said support surface;
logic for processing said images to generate output signals that are indicative of movement of said computer pointing peripheral;
logic for analyzing said images for at least one characteristic;
logic for modifying an image exposure time of said imaging array, wherein said logic for modifying is responsive to said logic for analyzing; and
logic for modifying an intensity of illumination provided by said illumination element when said image exposure time fails to satisfy an operating parameter.

10. The computer pointing peripheral of claim 9 wherein said logic for modifying an intensity of illumination controls a drive current provided to said illumination element.

11. The computer pointing peripheral of claim 9 wherein said illumination element is a coherent light source.

12. The computer pointing peripheral of claim 9 wherein said illumination element is a highly directional light source.

13. The computer pointing peripheral of claim 9 wherein said at least one image characteristic is a parameter defining a threshold average pixel value.

14. The computer pointing peripheral of claim 9 wherein said at least one image characteristic is a parameter defining a maximum pixel value.

15. The computer pointing peripheral of claim 9 further comprising:
logic for generating a control signal to operate a shutter according to a number of clock signals, wherein said logic for generating operates in response to said logic for modifying an image exposure time.

16. The computer pointing peripheral of claim 15 wherein said logic for modifying an image exposure time determines whether said number of clock cycles is within a predetermined range.

17. A computer pointing peripheral, comprising:
means for illuminating a support surface;
means for capturing images of said support surface;
means for processing said images to generate output signals that are indicative of movement of said computer pointing peripheral;
means for analyzing said images for at least one characteristic;
means for modifying an image exposure time of said imaging array according to said at least one characteristic; and
means for modifying an intensity of illumination provided by said means for illuminating when said image exposure time fails to satisfy an operating parameter.

18. The computer pointing peripheral of claim 17 wherein said means for analyzing determines whether an average pixel value fails to satisfy a predefined value.

19. The computer pointing peripheral of claim 17 wherein said means for analyzing determines whether a maximum pixel value fails to satisfy a predefined value.

20. The computer pointing peripheral of claim 17 wherein said means for modifying an intensity of illumination determines whether said image exposure time falls within a predetermined range.
